(19) United States
(12) Patent Application Publication
(10) Pub. No.: US 2013/0021144 A1
(43) Pub. Date: Jan. 24, 2013

(54) ALARM DEVICE FOR VEHICLE

(71) Applicant: Jun Hamachi, Osaka (JP)

(72) Inventor: Jun Hamachi, Osaka (JP)

(73) Assignee: SHARP KABUSHIKI KAISHA, Osaka (JP)

(21) Appl. No.: 13/638,389

(22) PCT Filed: Mar. 22, 2011
(86) PCT No.: PCT/JP2011/056755

§ 371 Date: Sep. 28, 2012

(30) Foreign Application Priority Data
Apr. 2, 2010 (JP) 2010-086086

(51) Int. Cl. G08B 6/00

(52) U.S. Cl. 340/425.5

(57) ABSTRACT

An alarm device 1 for a vehicle is provided with at least two tactile units 11Ra to 11Rd and 11La to 11Ld provided so as to respectively correspond to two or more different portions of at least one hand of the driver. A control unit 3 independently drives each of the at least two tactile units according to the type of alarm by a predetermined drive pattern. As a result of the configuration, a large amount of information can be given to the driver.

### TECHNICAL FIELD

The present invention relates to an alarm device for a vehicle that gives a prescribed alarm through tactile perception to a driver of the vehicle.

### BACKGROUND ART

An alarm device for a vehicle that gives an alarm through a method other than vision to inform a driver of a vehicle such as an automobile of an abnormality or danger has been known since before.

For example, Patent Document 1 discloses an alarm device for a vehicle that prompts a driver to perform a collision avoidance maneuver if there is a risk of a collision. This alarm device for a vehicle detects the direction relative to the vehicle where an obstacle is present and causes a prescribed part of the steering wheel corresponding to the direction of the obstacle to vibrate, if there is a risk that the vehicle will collide with the obstacle. Specifically, if the obstacle is in front of the vehicle to the left, then only a right-side region 101R of a steering wheel 100 shown in FIG. 6 is caused to vibrate. If the obstacle is in front of the vehicle to the right, then only a left-side region 101L of the steering wheel 100 is caused to vibrate. If the obstacle is in front of the vehicle, then both the right-side region 101R and the left-side region 101L of the steering wheel 100 are caused to vibrate. A collision is avoided by relying on the fact that when a vibration from the right-side region 101R and/or the left-side region 101L of the steering wheel 100 is transmitted to a palm of the right hand and/or the left hand of the driver, then the muscle of the arm to which the vibration is transmitted reflexively contracts, thus causing the steering wheel 100 to be turned in a direction opposite to that of the obstacle.

### RELATED ART DOCUMENT

### Patent Document

Patent Document 1: Japanese Patent Application Laid-Open Publication No. 2008-158671

### SUMMARY OF THE INVENTION

### Problems to be Solved by the Invention

With the conventional alarm device for a vehicle described above, a vibration is transmitted only to the right hand, left hand, or both of the driver. In other words, only three types of alarms can be given to the driver. Therefore, there is a problem that the amount of information that can be given to the driver is small.

The present invention aims to solve the problem of the above-mentioned conventional alarm device for a vehicle by providing an alarm device for a vehicle that can give a large amount of information to the driver.

### Means for Solving the Problems

An alarm device for a vehicle of the present invention gives a prescribed alarm to a driver of a vehicle, and includes: at least two tactile units provided so as to correspond respectively to two or more different regions on at least one hand of the driver; and a control part that drives the at least two tactile units. The control part independently drives the respective at least two tactile units with a predetermined drive pattern, to correspond to the type of alarm.

### Effects of the Invention

According to the present invention, at least two tactile units that are independently driven are provided so as to correspond respectively to two or more different regions in at least one hand of the driver. Therefore, the present invention can apply differing tactile stimuli to each of the two or more different regions in one hand unlike the above-mentioned conventional alarm device that applies a tactile stimulus to the whole hand. As a result, the number of tactile units disposed can be easily increased, and by increasing the number of tactile units, a large amount of information can be given to the driver through the tactile units. Also, by changing the drive pattern for one tactile unit in accordance with the type of alarm, a variety of information can be given to the driver through the one tactile unit. Therefore, the alarm device for a vehicle of the present invention can give a large amount of information to the driver.

### BRIEF DESCRIPTION OF THE DRAWINGS

FIG. 1 is a drawing that schematically shows a steering wheel of a vehicle equipped with tactile units that constitute an alarm device for a vehicle according to Embodiment 1 of the present invention.

FIG. 2 is a drawing that shows a schematic configuration of a tactile unit shown in FIG. 1.

FIGS. 3A and 3B are drawings that show examples of variations over time in the amount of movement in a moveable part of the tactile unit shown in FIG. 2.

FIG. 4 is a drawing that shows a schematic configuration of an alarm device for a vehicle according to Embodiment 1 of the present invention.

FIG. 5 is a drawing that schematically shows one pair of gloves equipped with tactile units that constitute an alarm device for a vehicle according to Embodiment 2 of the present invention.

FIG. 6 is a drawing that shows regions on a steering wheel that are caused to vibrate by a conventional alarm device for a vehicle.

### DETAILED DESCRIPTION OF EMBODIMENTS

In the present invention, there are no special limitations in terms of the definition of a vehicle, which includes all vehicles such as automobiles, two-wheeled vehicles, and railway vehicles for which it is desirable for an alarm to be given to the driver. Among these, it is preferable for the vehicle to be an automobile or a two-wheeled vehicle, and in particular, an automobile.

An alarm is for warning a driver of a vehicle, and the object to be warned about has no special limitations, but examples can be given such as danger with the possibility of affecting the vehicle and the passengers therein, an abnormality in the vehicle itself, or an abnormality of the environment external to the vehicle.

By giving an alarm through tactile units, the driver can be informed of the alarm without being distracted from the task of driving.

In the above-mentioned alarm device for a vehicle of the present invention, it is preferable for the at least two tactile units to be provided on a steering wheel of the vehicle. The driver is constantly gripping the steering wheel while driving, and therefore, by providing the steering wheel with tactile units, the driver can be reliably informed of an alarm.

Alternatively, the at least two tactile units may be provided on a glove that a driver of the vehicle wears. With this configuration, the driver can be reliably informed of an alarm regardless of where on the steering wheel the driver grips. In particular, it is preferable for the tactile units to be provided on the gloves if the vehicle is a two-wheeled vehicle.

It is preferable for the drive pattern to be defined by the intensity and the period with which the tactile units are driven. By changing the intensity and the period with which the tactile units are driven, an even greater amount of information can be given to the driver. Also, it becomes easier for the urgency of the alarm to be conveyed to the driver intuitively.

It is preferable for the at least two tactile units to apply a vibrational or electrical stimulus to a hand of the driver. With this configuration, the driver can be informed of an alarm through a simple configuration.

It is preferable for the at least two tactile units to include a solenoid coil. With this configuration, a tactile unit with a simple configuration that is low-cost and that is highly reliable can be attained.

It is preferable for the control part to include a database for alarm types that stores situations for which an alarm is to be given to a driver. In this case, it is preferable for the situations stored in the database for alarm types to be able to be added and/or deleted. With this configuration, the situations for which the alarm is given can be freely set depending on the driver, and therefore, the alarm can be customized.

It is preferable for the control part to include a database for drive patterns that stores the drive patterns. In this case, it is preferable for the drive patterns stored in the database for drive patterns to be able to be added, changed, and/or deleted. With this configuration, it is possible to change the drive pattern depending on the driver, and therefore, the alarm can be customized so as to be easily perceived by the driver.

The present invention will be described in detail below while showing preferred embodiments. However, it goes without saying that the present invention is not limited to the embodiments below. For ease of description, the drawings to be referred to in the description below are simplified to show only the main members necessary for describing the present invention out of the components of the embodiments of the present invention. Therefore, it is possible to provide the present invention with appropriate components not shown in the drawings below. Also, the dimensions of the members of the drawings below do not indicate faithfully the actual dimensions of the components or the ratio of the dimensions of the members to each other or the like.

### Embodiment 1

Embodiment 1 describes an alarm device for a vehicle that gives a prescribed alarm to a driver via a steering wheel of the vehicle. Although a case in which the vehicle is an automobile is described as an example in the present embodiment, it goes without saying that the embodiment can be applied to a vehicle other than an automobile.

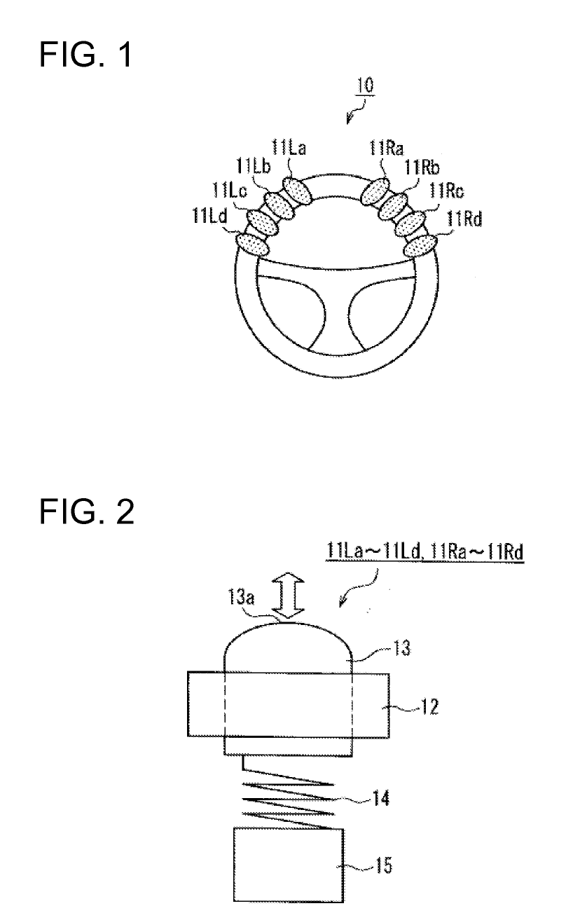

FIG. 1 is a drawing that shows a schematic configuration of a steering wheel 10 of a vehicle that is equipped with an alarm device for a vehicle according to Embodiment 1 of the present invention. The steering wheel 10 is provided with tactile units 11Ra to 11Rd and tactile units 11La to 11Ld in the regions where the right hand and the left hand of the driver grip. The tactile units 11Ra, 11Rb, 11Rc, and 11Rd are provided in positions where the index finger, the middle finger, the ring finger, and the little finger of the right hand of the driver are in contact respectively, while the tactile units 11La, 11Lb, 11Lc, and 11Ld are provided in positions where the index finger, the middle finger, the ring finger, and the little finger of the left hand of the driver are in contact respectively, when the driver is gripping the steering wheel 10 during normal driving. The tactile units 11Ra to 11Rd and 11La to 11Ld respectively apply a stimulus to the corresponding finger of the driver through vibration. The positions of the tactile units 11Ra to 11Rd and 11La to 11Ld may be made so as to be freely adjustable on the steering wheel 10 to correspond to the positions where the driver normally grips the steering wheel 10.

A schematic configuration of the tactile units 11Ra to 11Rd and 11La to 11Ld will be described with reference to FIG. 2. The tactile units 11Ra to 11Rd and 11La to 11Ld are provided with a solenoid coil 12, a moveable part 13 that is inserted into the solenoid coil 12, and a spring 14 of which one end is fixed to a fixed part 15 and the other end is fixed to the moveable part 13. The moveable part 13 is made of a material that includes a magnetic substance such as iron or nickel. The spring 14 elastically holds the moveable part 13 such that when there is no change in a current flowing through the solenoid coil 12, the moveable part 13 is in a prescribed position (rest position). When the current flowing through the solenoid coil 12 is changed, the moveable part 13 moves from the rest position according to the change in current, due to electromagnetic induction. By continuously changing the current, the moveable part 13 vibrates up and down, with the rest position as the center. The amplitude of the moveable part 13 is proportional to the current. Such tactile units 11Ra to 11Rd and 11La to 11Ld are arranged on the steering wheel 10 such that tips 13a of the moveable parts 13 protruding from the solenoid coils 12 are in contact with the fingers of the driver. Therefore, the driver can feel the vibration of the moveable parts 13 through the fingers.

By controlling the change in the current that flows through the solenoid coil 12, the moveable part 13 can be vibrated at varying amplitudes, or the intensity of vibration of the moveable part 13 can be changed at an appropriate rhythm by periodically changing the amplitude of the moveable part 13.

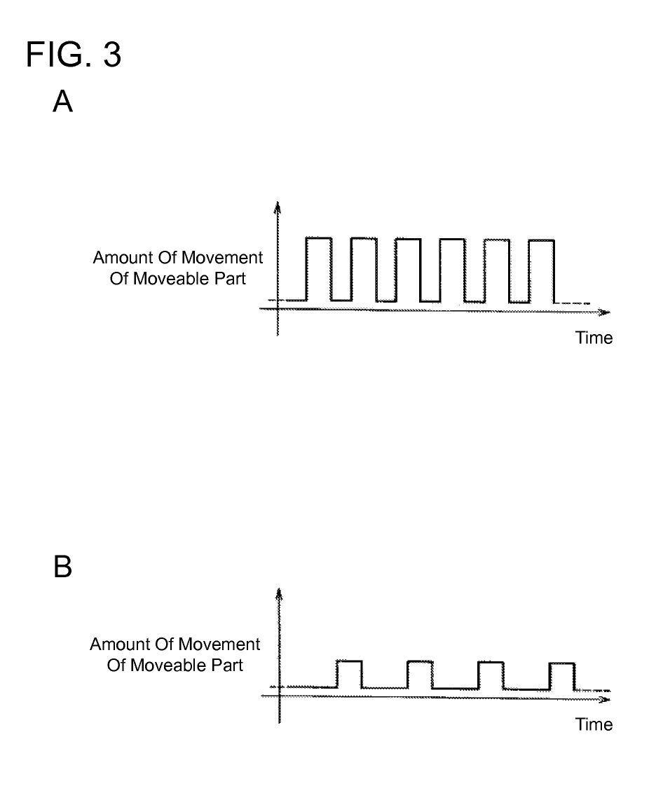

FIGS. 3A and 3B are drawings that show examples of variations over time in the amount of movement (in other words, the amplitude) of the moveable part 13. For example, if an alarm indicating a high degree of urgency or danger is given, the amount of movement of the moveable part 13 can be made large, and the period with which the amount of movement of the moveable part 13 changes can be made short, as shown in FIG. 3A. On the other hand, if an alarm indicating a low degree of urgency and danger is given, the amount of movement of the moveable part 13 can be made small and the period with which the amount of movement of the moveable part 13 changes can be made long, as shown in FIG. 3B. As such, by changing the size of the amplitude (in other words, how intense the vibration is) and the period of the amplitude change (in other words, the change in intensity of the vibration), the moveable part 13 can be vibrated at varying vibration patterns.

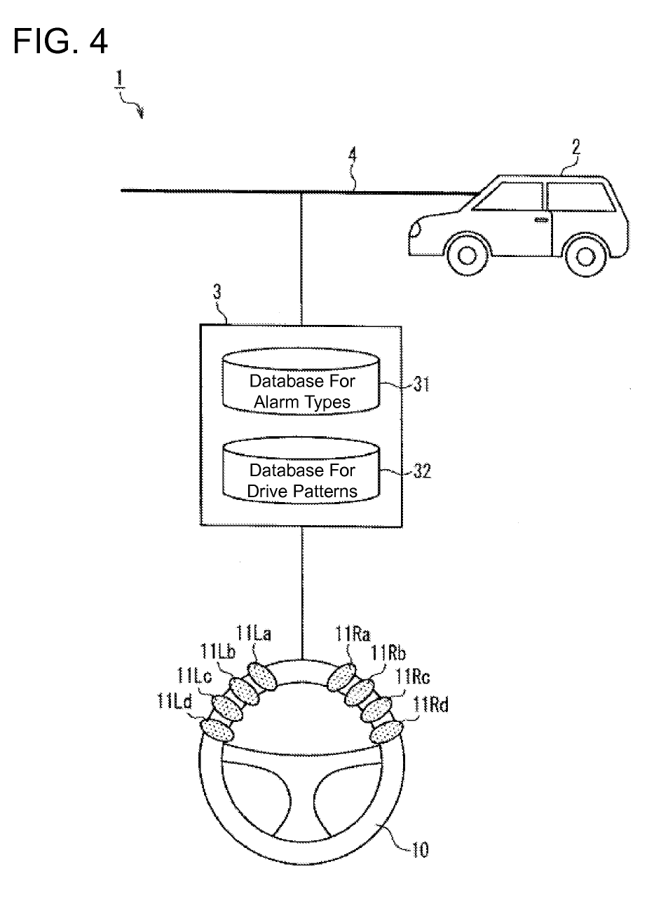

FIG. 4 is a drawing that shows a schematic configuration of an alarm device 1 for a vehicle according to the present Embodiment 1. The alarm device 1 for a vehicle is provided with a control board (control part) 3 installed on a vehicle 2. The control board 3 is connected to a CAN (controller area network) 4 of the vehicle 2, and is connected to the tactile units 11Ra to 11Rd and 11La to 11Ld of the steering wheel 10. The control board 3 is provided with a database for alarm types 31 and a database for drive patterns 32.

Various situations (referred to as “situations for which an alarm is given”) for which an alarm should be given to the driver are stored in advance in the database for alarm types 31. There are no special limitations on situations for which an alarm is given, but examples include danger of frontal collision, danger of rear collision, engine abnormalities, battery abnormalities, brake abnormalities, excessive speed, and abnormal amounts of rain. The system can be configured such that situations for which an alarm is given can be newly added, deleted, or the like freely by a seller, a driver (user), or the like of the automobile 2.

The drive patterns of the tactile units 11Ra to 11Rd and 11La to 11Ld are stored in the database for drive patterns 32. There are no special limitations on the drive patterns, but the drive patterns can be set by combining conditions such as which of the tactile units 11Ra to 11Rd and 11La to 11Ld to drive, the drive intensity of the tactile units that are driven, and the period with which the drive intensity of the tactile units that are driven changes. The system can be configured such that these drive patterns can be newly added, changed, deleted, or the like freely by a seller, a driver (user), or the like of the automobile 2.

The drive patterns stored in the database for drive patterns 32 are associated with each situation for which an alarm is given, which is stored in the database for alarm types 31. The association of the situation for which an alarm is given to the drive pattern may be freely changeable by a seller, a driver (user), or the like of the automobile 2.

The control board 3 determines whether or not a signal indicating an abnormal situation received via the CAN 4 corresponds to any situation for which an alarm is given, which is stored in the database for alarm types 31. If the abnormal situation signal corresponds to a situation for which an alarm is given, a drive pattern corresponding to the situation for which an alarm is given is read from the database for drive patterns 32, and the tactile units 11Ra to 11Rd and 11La to 11Ld are driven with the drive pattern. The driver feels the drive pattern of the tactile units 11Ra to 11Rd and 11La to 11Ld through fingers of both hands, recognizes what the situation for which the alarm is given is based on the drive pattern, and takes necessary measures.

The tactile units 11Ra to 11Rd and 11La to 11Ld, which are provided to correspond to each finger of the driver, are driven independently with a prescribed drive pattern. Through combinations such as vibrating or not vibrating each of the eight tactile units 11Ra to 11Rd and 11La to 11Ld, a total of 256 (2⁸) types of alarms can be given. Also, by changing the vibration pattern of individual tactile units, a plurality of types of alarms can be given through one tactile unit. Therefore, as a result of these combinations, a large number of types of alarms can be given to the driver. If there is a danger of collision with an obstacle in the front right direction, for example, it is possible to drive all of the tactile units 11Ra to 11Rd corresponding to the right hand. In this case, the intensity of vibration and the period of amplitude change of the tactile units 11Ra to 11Rd can be changed to correspond with the distance to the obstacle, the relative speed to the obstacle, and the like. As such, more information can be given to the driver through the steering wheel 10 in the present Embodiment 1 compared to conventional devices.

### Embodiment 2

The present Embodiment 2 differs from Embodiment 1 in which the tactile units are installed on the steering wheel 10, in that the tactile units are installed on gloves that a driver of a vehicle wears. The differences from Embodiment 1 will be described below.

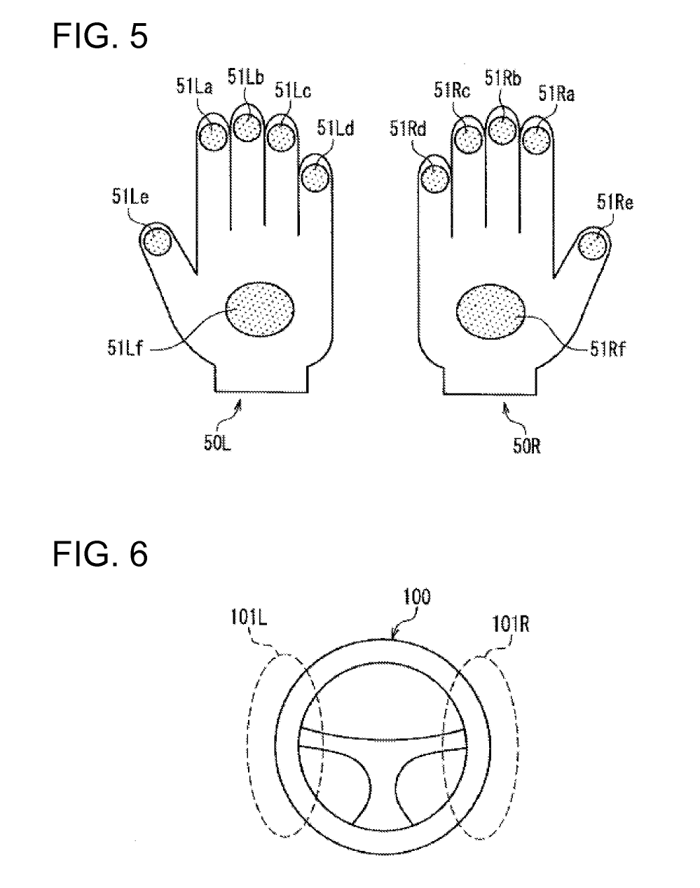

FIG. 5 is a drawing that schematically shows one pair of gloves 50R and 50L equipped with tactile units that constitute an alarm device for a vehicle according to the present embodiment. The right hand glove 50R is provided with tactile units 51Ra to 51Rf and the left hand glove 50L is provided with tactile units 51La to 51Lf. The tactile units 51Ra, 51Rb, 51Rc, 51Rd, 51Re, and 51Rf are provided in positions where the index finger, middle finger, ring finger, little finger, thumb, and palm of the right hand are in contact, respectively, when the glove 50R is worn on the right hand of the driver. Similarly, the tactile units 51La, 51Lb, 51Lc, 51Ld, 51Le, and 51Lf are provided in positions where the index finger, middle finger, ring finger, little finger, thumb, and palm of the left hand are in contact, respectively, when the glove 50L is worn on the left hand of the driver.

The tactile units 51Ra to 51Rf and 51La to 51Lf respectively apply a stimulus through vibration to the corresponding regions of the hand of the driver. The configuration of the tactile units 51Ra to 51Rf and 51La to 51Lf does not have any special limitations, and may be the same as that of Embodiment 1, for example. Similar to Embodiment 1, the tactile units 51Ra to 51Rf and 51La to 51Lf are driven independently with a prescribed drive pattern. Through combinations such as driving or not driving each of the 12 tactile units 51Ra to 51Rf and 51La to 51Lf, a total of 4096 (2¹²) types of alarms can be given. Also, by changing the vibration pattern of individual tactile units, it is possible to send a plurality of types of alarms through one tactile unit. Therefore, through this combination, a large number of types of alarms can be given to the driver. As such, according to the present Embodiment 2, a larger amount of information can be given to the driver through the gloves 50R and 50L, compared to conventional devices.

In the present Embodiment 2, the tactile units are installed on the gloves as opposed to the steering wheel, and therefore, even if the driver changes where he/she grips the steering wheel while driving, the alarm can be reliably conveyed to the driver. The present Embodiment 2 can be preferably applied as an alarm device for a two-wheeled vehicle, which is often ridden while wearing gloves.

Embodiments 1 and 2 are only illustrative, and the present invention is not limited thereto and can be changed freely.

For example, although in Embodiment 1, each hand was provided with 4 tactile units to form a total of 8, and in Embodiment 2, each hand was provided with 6 tactile units to form a total of 12, the number of tactile units is not limited to these examples, and may be greater or less than these as long as a plurality of tactile units are provided to correspond, one-to-one, to two or more different regions of at least one hand. With this structure, a plurality of types of alarms can be conveyed to the driver through different regions of one hand.

Also, the position of the tactile units is not limited to the above-mentioned embodiments. The tactile units can be disposed so as to be in contact with appropriate regions of the five fingers, the palm, and the like. The position of the tactile unit may be made so as to be freely changeable by a driver or the like.

The configuration of the tactile unit is not limited to that of FIG. 2. A vibrating element that uses a piezoelectric element, a vibrating element in which an eccentric weight is installed onto a rotating shaft of a small motor, or the like may be used, for example. The stimulus applied to the driver from the tactile unit does not need to be a vibrational stimulus, and may be an electrical stimulus, for example. A tactile unit that applies an electrical stimulus does not have special limitations, but can be constituted of an electrode provided so as to come into contact with the hand of the driver and send a weak current to specific regions of the hand of the driver. Even in a case in which an electrical stimulus is applied, a large number of types of alarms can be conveyed to the driver by changing the drive pattern, or in other words, the pattern by which the voltage applied to the electrode changes. When installing tactile units on gloves as described in Embodiment 2, it is desirable for the tactile units to be small; therefore, it is preferable for a small tactile unit to be configured using an electrode that applies an electrical stimulus, a piezoelectric element that applies a vibrational stimulus, or the like.

The embodiments described above are meant only to clarify the technical details of the present invention. The present invention shall not be narrowly interpreted by being limited to such specific examples. Various changes can be made within the spirit of the present invention and the scope of the appended claims, and the present invention shall have a broad interpretation.

### INDUSTRIAL APPLICABILITY

The present invention can be used in a wide variety of areas as an alarm device installed in a vehicle such as an automobile or a two-wheeled vehicle.

### DESCRIPTION OF REFERENCE CHARACTERS

1 alarm device for vehicle

2 automobile

3 control board (control part)

31 database for alarm types

32 database for drive patterns

4 CAN (controller area network)

10 steering wheel

11Ra to 11Rd, 11La to 11Ld tactile units

12 solenoid coil

13 moveable part

14 spring

14 fixed part

50R, 50L gloves

51Ra to 51Rf, 51La to 51Lf tactile units

1. An alarm device for a vehicle that gives a prescribed alarm to a driver of a vehicle, comprising:
at least two tactile units provided so as to correspond respectively to two or more different regions on at least one hand of the driver; and
a control part that drives the at least two tactile units,
wherein the control part independently drives the respective at least two tactile units with a predetermined drive pattern, to correspond to a type of alarm.

2. The alarm device for a vehicle according to claim 1, wherein the at least two tactile units are provided on a steering wheel of the vehicle.

3. The alarm device for a vehicle according to claim 1, wherein the at least two tactile units are provided on a glove that a driver of the vehicle wears.

4. The alarm device for a vehicle according to claim 1, wherein the drive pattern is defined by an intensity and a period with which the tactile units are driven.

5. The alarm device for a vehicle according to claim 1, wherein the at least two tactile units apply a vibrational or electrical stimulus to a hand of the driver.

6. The alarm device for a vehicle according to claim 1, wherein the at least two tactile units include a solenoid coil.

7. The alarm device for a vehicle according to claim 1, wherein the control part comprises a database for alarm types that stores situations for which an alarm is to be given to a driver, and the situations stored in the database for alarm types can be added and/or deleted.

8. The alarm device for a vehicle according to claim 1, wherein the control part comprises a database for drive patterns that stores the drive patterns, and the drive patterns stored in the database for drive patterns can be added, changed, and/or deleted.
